(19) United States
(12) Patent Application Publication
(10) Pub. No.: US 2005/0104555 A1
(43) Pub. Date: May 19, 2005

(54) Secure recharge station

(76) Inventor: Phillip Simmonds-Short, Essex (GB)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/713,423

(22) Filed: Nov. 17, 2003

(51) Int. Cl. H02J 7/00

(52) U.S. Cl. 320/107; 340/5.1

(57) ABSTRACT

A recharge station is provided where users can deposit devices for recharging, and the mobile devices are held by a security system such that unauthorised removal is prevented.

The present invention relates to a secure recharge station for providing recharge facilities for mobile devices.

Mobile devices, such as telephones and personal computing devices are powered by internal batteries. The battery life for these devices can vary enormously depending on use, and indeed age of battery. Additionally, users may neglect to recharge the batteries in a timely manner and this can result in the mobile device becoming short on power whilst it and the user are away from the user's home or office and their recharge station.

According to a first aspect of the present invention there is provided a mobile device recharge station comprising: at least one docking station for supplying at least one of power and data to a mobile unit; and a security system arranged to inhibit unauthorised removal of a mobile device from the at least one docking station.

Preferably the or each docking station is lockable. Thus the docking station may, advantageously, comprise a container or recess which has an openable closure, such as door, associated with it. In a preferred embodiment a plurality of docking stations are provided and each one is accessible via a front panel of the recharge station such that the user approaches the front panel, opens the door to an empty station and can de posit their mobile device, such as a telephone, a personal computing device or a personal entertainment device in the docking station such that the mobile device can be recharged.

Advantageously, the user can secure their mobile device within the docking station, for example by closing the door and having it locked, such that unauthorised removal of their mobile device cannot occur. Advantageously the user establishes some shared secret or other mechanism for proving their identity such that their mobile device remains locked within the docking station until such time as they identify themselves to the recharge station such that the lock to the docking station containing their mobile device is released. A simple form of identity might be the establishment of a shared secret such as a password or pass code. The recharge station may generate a unique password and present this to the user when they deposit their phone. The password may, for example, be presented on a printed substrate which the user then has to keep secret. Alternatively, the user may have the opportunity to define their own pass code. However other identification systems can also be used. Thus the user may be presented with a key or token which they physically have to present to the recharge station in order to release their mobile device. Alternatively, the user may also identify themselves via biometric data such as finger print analysis, iris pattern analysis or even voice analysis. Systems for sharing such secrets or providing key based or biometric data based confirmation of identity are well known in the art and are indeed commercially available and hence need not be described in filter detail here.

Advantageously the docking station can accept devices of different makes and from different manufacturers. Some manufacturers may include “plug and play” technology within their devices such that the device can automatically be identified by the recharge station. However where this has not been done the user may be presented with a user interface such that they can enter their device details. For convenience the user interface may include a menu driven system such that the user is presented with a hierarchical series of choices and at each level only has to make a simple choice in order to eventually arrive at the correct identification of their device. Preferably the choices are presented to the user by way of a touch screen system such that interaction with the system requires no special skills and is intuitive. However entry devices such as keyboards and/or mice, track balls and joy sticks may also be included such that the user can input data via a graphical user interface.

Advantageously the recharge station includes one or more devices for enabling payment to be collected from users. This may be in the form of a conventional coin feed mechanism, a credit or debit card reader or a interface for enabling a user to charge their services against an account. Therefore, if a user wishes to recharge their mobile phone they may be presented with an option to charge the cost of recharging the phone against their telephone bill.

Advantageously the recharge station can also provide data communication with external data providers. Thus the user could present an MP3 player or other personal entertainment device (which may or may not be integrated within a mobile telephone or a computing device) and select via a browser an option to download entertainment media to their mobile device. The download can occur on its own or in addition to a charging step and the user is able to leave their device in the recharge station while this action is taking place in the assurance that it is protected from theft. The user may then go and perform some other task. Thus if the recharge station is located in a shopping mall the user may go shopping. If the recharge station is located in a cafe or restaurant then they may enjoy a drink or a meal whilst their mobile device is being recharged and/or having data transferred to (or indeed from) it.

The owner or manager of the recharge station may configure the station such that a minimum time is provided before mobile devices can be released. This enables a retail outlet to effectively hold customers captive within the retail outlet whilst they are waiting for their mobile device to be released and/or gives them the opportunity to offer differing levels of service whereby a paying service will enable the mobile device to be released more quickly than a free service or a service attracting a lesser payment.

The present invention will further be described, by way of example, with reference to the accompanying drawings in which:

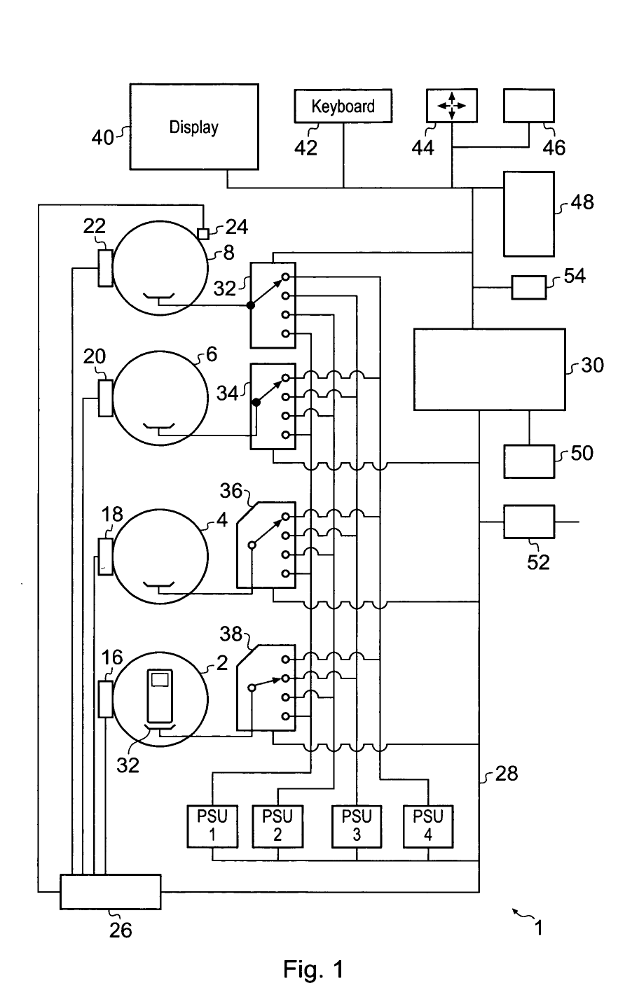

FIG. 1 schematically illustrates the components of a recharge station constituting an embodiment of the present invention;

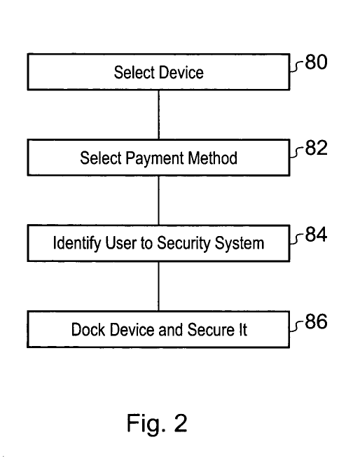

FIG. 2 illustrates a flow chart for the presentation of a mobile device to a docking station within the recharge station;

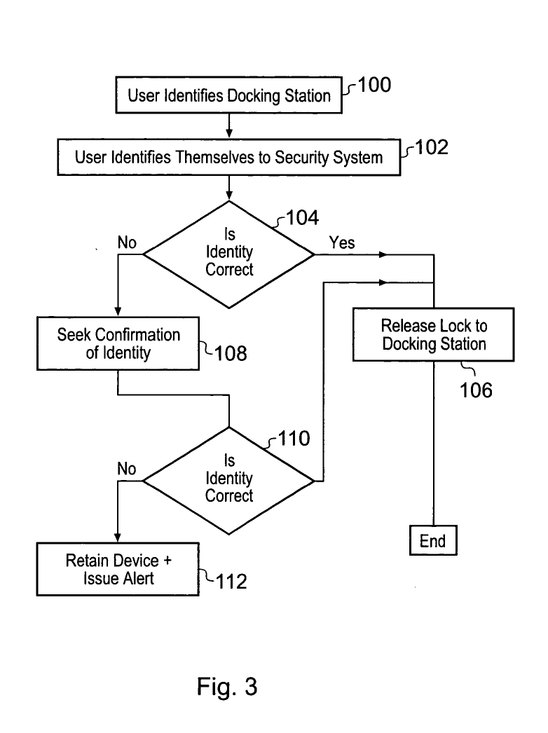

FIG. 3 illustrates a flow chart for the removal of a mobile device from a docking station within the recharge station according the present invention; and

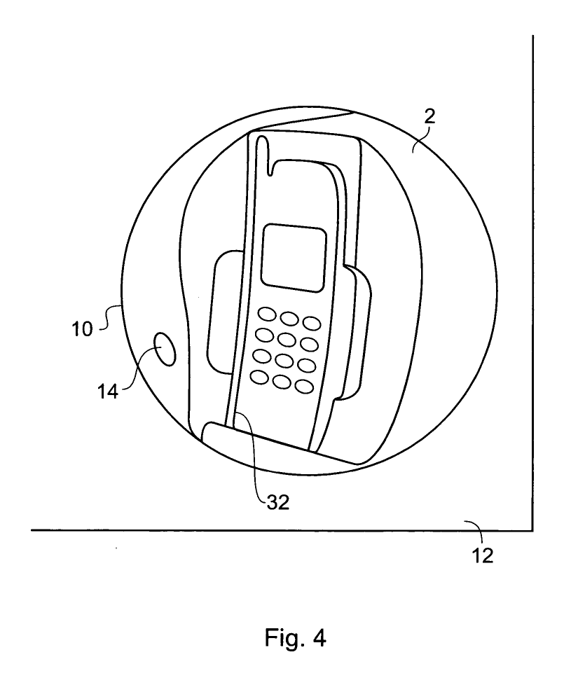

FIG. 4 is a perspective view of an embodiment of a docking station.

As shown in FIG. 1, a recharge station, generally designated 1, comprises a plurality of docking stations, 2, 4, 6 and 8. Each docking station defines an enclosure in which a mobile device may be securely deposited. A perspective view of a exemplary docking station is shown in FIG. 4. Thus the enclosure 2 is in the form of a box or cavity which is accessible via a door 10. The opening to the enclosure 2 is mounted on a panel 12 such that it is intuitive to a user that they need to open the door 10 to gain access to the enclosure and to close the door 10 in order to secure the mobile device within the enclosure. As shown in FIG. 4 the door 10 has an attachment 14 for engaging with a locking mechanism 16, as schematically illustrated in FIG. 1, such that the enclosure 2 can be securely locked thereby preventing access to its contents. The enclosures 4, 6 and 8 are provided with respective doors and also respective locking mechanisms 18, 20 and 22. Returning to FIG. 4, it could be seen that the door is hinged to the enclosure 2 but the details of the door design, hinge mechanism and locking mechanism may be varied by the person skilled in the art and need not be described further here.

Returning to FIG. 1, each enclosure may also be provided with a door switch, of which only one 24 is illustrated in FIG. 1, such that an attempt to open the door may be detected and signalled to a door and lock controller 26. The door and lock controller 26 is in communication via a data bus 28 with a data processor 30 which controls the operation of the recharge station. Each of the docking stations includes a connector or adaptor to allow galvanic connection to be made with the mobile device contained therein. This may be in the form of plugs attached to cables such that the user has to plug their mobile device in prior to shutting the door, but in a preferred embodiment is provided by a cradle 32 which serves to engage with the case of the mobile device and also hold it correctly in position such that connectors on the mobile device engage with contacts provided within the cradle 32.

A plurality of power supplies, PSU1, PSU2, PSU3 and PSU4 are provided and each one can be individually connected to any one of the docking stations 2, 4, 6 and 8 via electronically controlled power supply selectors 32, 34, 36 and 38 which are under the control of the data processor 30. Each of the power supplies PSU1, PSU2, PSU3 and PSU4 is also under the control of the data processor 30 and hence the supply voltage and duration of supply to the mobile device in each docking station can be individually controlled. This is beneficial since different models of device may require different supply voltages. It also enables the performance of each device to be individually monitored such that the devices do not become overcharged or that an electrical failure in any one of the devices does not cause the charging functions to the other docking stations to become compromised.

A user interface comprises a display 40, which advantageously is a touch screen display, and optionally a keyboard 42, a pointing device 44 such a mouse, track ball or joystick, and a biometric data collection device 46. Thus a user can be displayed a welcome message on the display 40 when they first approach the device and then guided through a process, which will be described in greater detail hereinafter, where they are given an opportunity to enter details about their mobile device such that it can be correctly identified and the appropriate power supply configuration selected, and such that they can then also define a secret which they share with the recharge station, such as a password, such that they and only they are able to retrieve their mobile device from the docking station. However where users do not wish to define a password, the biometric sensor 46, such as an iris scanner or fingerprint identifier, may be invoked in order to capture data identifying the owner of the device which is being deposited in the recharge station. One or more payment collection devices 48 are also provided. Thus the payment collection device 48 may include a coin feed apparatus for accepting coins and determining their value, or a card reader enabling payments to be deducted from charge cards or credit cards. Additionally, given that a mobile device such as a phone inherently carries a unique identity, the user may select an option to have the cost of using the recharge station charged against their mobile phone account. The data processor receives information from the keyboard 42, the pointing device 44, the biometric device 46, the payment device 48 and optionally from the display 40 if the display is a touch screen display. The data processor 30 also presents guidance and instructions to the user via the display 40 and/or through another user interface device such as a loudspeaker (not shown). The dataprocessor 30 is responsive to instructions held within a memory 50 which enable it to perform its various tasks and also to control the operation of the power supply units PSU1 to PSU4 and to control the operation of the locks 16, 18, 20 and 22 via the lock controller 26.

The data processor 30 can also establish communication via, for example, modem 52, such that data can be sourced from external data providers and provided to the mobile devices. Thus, where a mobile device is a telephone with integrated music player or is indeed an MP3 player, then the user may use the recharge station via browser capability to interface with a data download site and, for example, to download music to their mobile device. The provision of this service can be logged by the data processor 30 and an appropriate charge made to the user.

FIG. 2 schematically illustrates a flow chart for presenting a device to the recharge station. Initially a user approaches the recharge station and indicates via the display 40 or keyboard 42 that they wish to deposit their device. The user may be presented with a choice of languages and then asked to identify and select their mobile device at step 80. Assuming their device can be identified control then passes to step 82 where the user is asked to select their payment method. The payment method supported may vary depending on the preferences of the operator of the recharge station. It might be expected that some operators might wish to offer some or all of the services as a complimentary service. Whereas other operators may require payment and may limit their payment methods to, for example, charging against a charge card or charging against a mobile phone bill. However other operators may also accept coinage. Thus the payment methods presented will be appropriate to that particular installation. Once the user has presented the payment method at step 82, control is passed to step 84 where the user and the security system define a shared secret. Typically this will be a password. Again, depending on the preferences of the operator of the recharge station either the password is generated automatically within the data processor and is presented to the user, for example via printer 54, or alternatively the user is free to pick and choose their own password. Typically if a user chooses their own pass word they will be asked to enter it twice in order that the system can validate that the password has not been mistyped. However the user may wish to rely on other security systems, such as the presentation of a physical token or key, or use of biometric data. Once the shared secret or identifier has been defined, control is then passed to step 86 where the user is instructed to place their device in a designated recharge station and then to shut the door. Once the door is shut the data processor detects this via the door switch 24 and then activates the lock 22 via the lock controller 26 to ensure that the mobile device is now locked within the relevant docking station.

FIG. 3 schematically illustrates a process for recovering the mobile device from the recharge station. The process starts at step 100 where the user returns to the recharge station, and identifies the docking station which contains their mobile device to the security system implemented within the data processor 30. Control then passes to step 102 where the user is prompted to identify themselves to the security system, for example by entering their password or by presenting themselves to the biometric scanner. A check is made at step 104 to see if the user's identity matches the identity which has been stored as belonging to the owner of the mobile device. If step 104 determines that the person seeking to remove the device has the same identity as the person who deposited the device, then control is passed to step 106 where the data processor 30 instructs the lock controller 26 to release the lock of the relevant docking station thereby enabling the user to remove their mobile device. However if step 104 determines that the identity is incorrect then control is passed to 108 where the user is instructed to reidentify themselves to the security system. Control is then passed to step 110 where an identity check is made once more. If the user's identity matches that logged against the relevant mobile device then control is passed to 106, otherwise control is passed to step 112 where the device is marked for retention within the recharge station and an alert is issued to the operator.

As an enhanced security feature, a second internal door or other locking mechanism may be provided such that if the system determines that an unauthorised attempt is being made to remove a mobile device from the recharge station, then additional physical security can be invoked in order to render that task more difficult and optionally or alternatively an alarm may be raised.

It is thus possible to provide a recharge station allowing for mobile devices to have a power recharge and/or data download in public spaces whilst maintained in secure region thereby preventing their theft.

1. A mobile device recharge station comprising:
at least one docking station for supplying at least one of power and data to a mobile device; and
a security system arranged to inhibit unauthorised removal of a mobile device from the at least one docking station.

2. A mobile device recharge station as claimed in claim 1, wherein the or each docking station comprises a container having an openable closure and a lock, and wherein the lock inhibits opening of the openable closure by unauthorised individuals.

3. A mobile device recharge station as claimed in claim 2, in which the security system includes a security controller for instructing a selected lock to release the openable closure associated with the lock.

4. A mobile device recharge station as claimed in claim 1, where in the security system includes an access controller for selectively allowing access to a selected one of the or each recharge stations.

5. A mobile device recharge station as claimed in claim 4, in which the security system requires an individual to identify their right to remove a mobile device from one of the docking stations before the security system permits access to the appropriate docking station.

6. A mobile device recharge station as claimed in claim 5, wherein the individual identifies themselves by way of one item selected from a list comprising:
entering a pass code;
providing a token;
providing a key; and
providing biometric data.

7. A mobile device recharge station as claimed in claim 5, wherein the security system requires an individual to agree identity information with the security system at the time of depositing the mobile device.

8. A mobile device recharge station as claimed in claim 7, in which the individual and the security system agree to identify information which comprises an item selected from a list comprising:
a shared secret;
a token;
a key; and
biometric data

9. A mobile device recharge station further including payment collection device such that a payment can be collected for recharging the mobile device.

10. A mobile device recharge station where the payment collection device includes at least one item selected from a list comprising:
a credit/debit card reader
a coin collection mechanism
a token collection mechanism
a data processor for raising a charge against an account.

11. A mobile device recharge station as claimed in claim 10, wherein the data processor is arranged to make a charge against a user's telephone account.

12. A mobile device recharge station as claimed in claim 1, further including a interface such that a user can identify the type of user device to the recharge station such that an appropriate power supply or suitably configured power supply is arranged to supply power to the mobile device.

13. A mobile device recharge station as claimed in claim 1, wherein the security system as claimed in claim 1, wherein the security system asserts an alarm if an unauthorised removal of a mobile device is attempted.

14. A mobile device recharge station as claimed in claim 1, further including a retention device for retaining the mobile device more securely in the event that an attempt is made to remove the mobile device.

15. A mobile device recharge station as claimed in claim 1, further including a user interface to enable a user to select data for transfer to or from the mobile device.

16. A mobile device recharge station as claimed in claim 15, wherein the user interface includes a browser or menu driven interface such that the user can select their data transfer options.

17. A mobile device recharge station as claimed in claim 15, further including payment accepting means for accepting payment for a data transfer.

18. A mobile device recharge station as claimed in claim 1, in which the docking stations are provided with connectors for connecting to mobile telephones.

19. A mobile device recharge station as claimed in claim 1, in which the docking stations are provided with connector for connecting to personal computing devices.

20. A mobile device recharge station as claimed in claim 1, in which the docking stations are provided with connectors for connecting to personal entertainment devices.
